(19) United States
(12) Patent Application Publication
(10) Pub. No.: US 2007/0237690 A1
(43) Pub. Date: Oct. 11, 2007

(54) FeCrAl ALLOY FOIL FOR CATALYTIC CONVERTERS AT MEDIUM HIGH TEMPERATURE AND A METHOD OF MAKING THE MATERIAL

(75) Inventors: Lichun Leigh Chen, Walpole, MA (US); Bijendra Jha, North Attleboro, MA (US)

Correspondence Address: PEARNE & GORDON LLP, 1801 EAST 9TH STREET, SUITE 1200, CLEVELAND, OH, 44114-3108, US

(73) Assignee: ENGINEERED MATERIALS SOLUTIONS, INC., Attleboro, MA (US)

(21) Appl. No.: 11/537,148

(22) Filed: Sep. 29, 2006

Related U.S. Application Data
(63) Continuation-in-part of application No. 10/914,457, filed on Aug. 9, 2004, now abandoned.
(60) Provisional application No. 60/493,168, filed on Aug. 7, 2003.

(51) Int. Cl. B23K 20/04; B01D 53/34

(52) U.S. Cl. 422/180; 148/531

(57) ABSTRACT

A FeCrAl alloy for catalytic converter substrates having excellent oxidation resistance and dimension stability at a medium high temperature, e.g. the temperature encountered by catalytic converter substrates in truck diesel engines, without necessary addition of extra Y, Hf, Zr, or rare earth elements beyond that inherently present in commercial stainless steel. A roll bonding and diffusion alloying annealing method is used for making such materials with the following two deviated paths. First, material in which layers of ferritic stainless steel and aluminum are solid state metallurgically bonded together forming a multilayer composite material. Such composite material is then further rolled to an intermediate foil gauge, cleaned, and then subjected to a thermal reaction to form a resulting uniform solid solution foil material followed by rolling to the final foil thickness. Alternatively, such composite material is further rolled to the final foil thickness, cleaned, and then subjected to a thermal in-situ reaction in the material after a honeycomb-like catalytic converter is made from the foil composite material. Both deviated approaches result in a uniform solid solution foil material.

### CROSS-REFERENCE TO RELATED APPLICATIONS

This application is a Continuation-In-Part of U.S. patent application Ser. No. 10/914,547 filed Aug. 9, 2004, which is a non-provisional of U.S. Provisional Patent Application No. 60/493,168 filed Aug. 7, 2003, both of which are incorporated herein by reference in their entirety.

This application relates generally to a method of producing an alloyed foil substrate material for use in diesel engine exhaust systems and other exhaust systems that operate at temperatures of up to at least 800° C., and more preferably up to 900° C. More specifically, this application relates to a method of producing an iron-chromium-aluminum alloy foil for use in catalytic converters without the addition of rare earth elements and is suitable for temperature of about at least 800° C.

### BACKGROUND OF THE INVENTION

This invention provides an alloy material having corrosion resistance at medium-high temperatures and a method of manufacture thereof. More particularly, the invention relates to a metal foil alloy material and a method for producing the metal foil alloy material for use in catalytic converters, especially for those used in diesel engines having exhaust temperatures which are lower than the exhaust temperatures of gasoline internal combustion engines.

Ceramic substrates have been the most common materials of choice in exhaust systems including, for example, catalytic converters, due to the low cost and adequate properties. Further, it has been known to use metal foil materials as substrates with an appropriate catalyst coating in place of ceramic material substrates. Such metal foil material has been made in the past by ingot metallurgy from steel sheets containing aluminum (Al) and also chromium (Cr), thereby forming FeCrAl alloys, which provide the desired corrosion resistance at elevated temperatures. These FeCrAl alloys, however, are difficult to produce by the conventional rolling and annealing processes. To overcome the processing difficulties, it has been suggested, as in EP application 91115501.8 (European Patent No. 0 475 420), to produce the foil by a rapid solidification processing method. It has also been suggested to coat the stainless steel in a molten bath of aluminum or aluminum alloy (U.S. Pat. Nos. 3,907,611, 3,394,659 and 4,079,157). The coated stainless steel is subjected to a heat treatment to form an alloy layer having Fe and Al as the main components. Still further, surface layers of aluminum in binder materials, as described in U.S. Pat. No. 4,228,203, have also been suggested. However, in all of these applications the control of process parameters is complex and expensive. Further, the final foil has not proven, in many cases, to have the desired corrosion/oxidation resistance at elevated temperatures as required in the catalytic converter industry.

Still two other approaches are to manufacture the catalytic converter substrate material by using a metallurgically bonded composite material with layers of ferritic stainless steel and aluminum as described in U.S. Pat. No. 5,366,139 and U.S Pat. No. 5,980,658 owned by the assignee of this instant application.

The FeCrAl alloy foils for use in catalytic converter in automobile gasoline engines requires good oxidation resistance and dimension stability up to 1100 to 1200° C. A gasoline engine FeCrAl alloy normally contains 18˜22 wt % chromium and 4.5˜6 wt % aluminum with of the addition of rare earth elements beyond that which is normally present in stainless steel. However, the cost associated with the addition of rare earth metal and the processing foil thickness is preventing a wide application of these FeCrAl type materials to catalytic converters in the diesel engines, where maximum service temperature is normally up to 600° C. FeCrAl alloy without the intentional addition of rare earth elements has now been found to provide adequate oxidation resistance and dimensional stability in applications such as a diesel engine where the environment is different from that of a gasoline engine. Further, the aforesaid FeCrAl alloy can be produced relatively inexpensively due to the lack of need for inclusion of rare earth elements.

### SUMMARY OF THE INVENTION

Accordingly, the present invention provides an innovative foil of alloys containing Cr between about 9 wt % to about 18 wt %, Al between about 4 wt % to about 9 wt %, without the addition of Y, Hf, Zr, or other rare earth elements. The invention also describes a method of manufacturing the aforementioned alloy to foil thickness that the resulting foils have excellent oxidation resistance and dimension stability in the temperature, commonly present in the catalytic converter of a diesel engines, up to about at least 800° C. and more preferably up to about at least 900° C. The foil material is more easily and more economically produced for high volume applications due to the elimination of Y, Hf, Zr, and/or other rare earth elements.

The new alloys of the invention contain Cr between about 9 wt % to about 18 wt % and Al between about 4 wt % to about 9 wt %. The alloys of the invention starts by bonding the commercial ferritic iron-chromium (FeCr) stainless steel, such as AISI405SS, 430SS, 439SS and 409SS, to the commercial pure aluminum This multilayer composite, comprising of sandwiched Al/FeCr stainless steel/Al, is further cold rolled down to an intermediate thickness or to a final foil thickness.

In one aspect of the invention, the multilayer composite is rolled to an intermediate thickness as mentioned previously. The intermediate thickness is a thickness which is between a thickness after bonding and a final thickness. The intermediate thickness multilayer composite is then diffusion heat treated at a temperature of between about 900° C. to about 1200° C. for a period of time that is sufficient for diffusion alloying to obtain a monolithic, uniform, solid solution alloy material. The monolithic, uniform, solid solution alloy material is then finish rolled to a final foil thickness. The final foil can then be used for catalytic converter fabrication, including forming the material into a honeycomb-like structure.

In another aspect of the invention, the roll-bonded multilayer Al/FeCr/Al composite is formed in the same manner as described above but is rolled to a final foil thickness rather than an intermediate thickness. A catalytic converter, including one with a honeycomb-like structure, can then be made directly from final thickness multilayer composite foil through certain processes, including slitting, cleaning, foil corrugation, corrugated and flat foils winding or stacking. The catalytic converter body is then heat treated at a temperature between about 900° C. and about 1200° C. for a period of time that is sufficient to cause diffusion of the various constituents in the layers of the composite material throughout the foil.

In both cases, with rolling to either an intermediate or final foil thickness, prior to the heat treatment of the material, it is desirable and beneficial to clean the outer surfaces of the roll-bonded composite material to prevent impurities in the final product. Preferably the cleaning method will be of such a nature as to avoid any disruption of the surface of the composite. Accordingly, while certain type of cleaning process may be used, others should be avoided due to their abrasive and disruptive nature.

Further, in both cases as described above (initial rolling to either an intermediate or final foil thickness), the composite forms a final material, after heating, having the complete presence of the constituents of the aluminum layer and the stainless steel layers intimately dispersed throughout the whole foil material. The semi-cyclic oxidation resistance and dimension stability attained from such a material are excellent at temperature of up to at least about 800° C. and more preferably up to at least about 900° C.

In a further aspect of the invention, the layers may comprise Al sandwiched between FeCr stainless steel layers. This material can then be processed according to either method (intermediate or final finish rolling) as described above.

The materials made from this invention may easily be made from starting materials that are commercially available, such as common grade stainless steel and aluminum. It is not necessary for alloys to contain additional, expensive Y, Hf, Zr, and/or other rare earth elements, normally utilized in alloys for conventional gasoline engine, to obtain the excellent cyclic oxidation resistance and dimension stability at a temperature of up to at least about 800° C. and more preferably up to at least about 900° C. which is typical for diesel engine applications.

These and other aspects of the invention can be realized from a reading and understanding of the detailed description and drawings.

### BRIEF DESCRIPTION OF THE DRAWINGS

FIG. 1 shows a side elevation view diagrammatically illustrating the bonding method of this invention;

FIG. 2 shows the composite material of this invention after bonding;

FIG. 3 diagrammatically shows the material of this invention after diffusion heat treatment.

FIG. 4 shows the material used in a catalytic converter.

FIG. 5 shows a photomicrograph of the material of FIG. 3

FIG. 6 shows the material oxidation weight gain in the samples by the first deviated manufacturing approach path at 800° C. temperature in air.

FIG. 7 shows the length change of the samples by the first deviated manufacturing approach path.

FIG. 8 shows the material oxidation weight gain in the samples by the second deviated manufacturing approach path at 800° C. temperature in air.

FIG. 9 shows the length change of the samples by the second deviated manufacturing approach path.

FIG. 10 shows the weight change of samples of the invention up to 900° C. compared to high chromium content alloys.

FIG. 11 shows the length change of samples of the invention up to 900° C. compared to high chromium content alloys.

### DETAILED DESCRIPTION OF THE PREFERRED EMBODIMENTS

Some aspects of this invention have been disclosed in provisional application Ser. No. 60/457,079, now U.S. application Ser. No. 10/807,792, incorporated herein by reference, and in U.S. application Ser. No. 10/914,457 (filed Aug. 9, 2004), from which this application claims priority as a continuation-in-part.

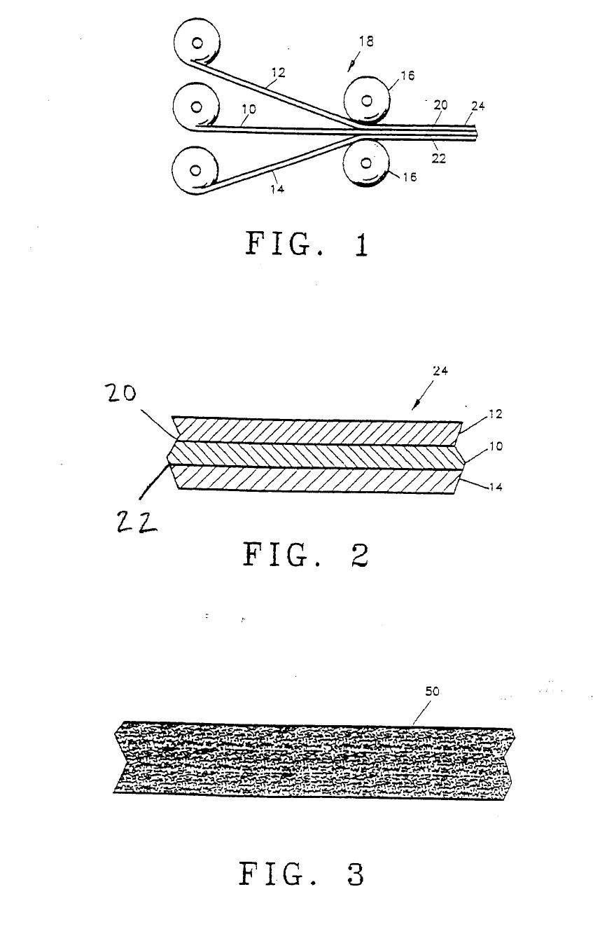

In accordance with the invention, a first central layer 10 of ferrous material, such as stainless steel, is sandwiched between two outer layers 12 and 14 of aluminum or aluminum alloy material. The three layers are passed between a pair of pressure rolls 16 in a conventional rolling mill 18 as shown in FIG. 1. The layers are pressed together with sufficient force to be reduced in thickness, and metallurgically bonded together along interfaces 20 and 22 between the metal layers wherein a composite multilayer metal material 24 is formed as shown in FIG. 2. The material is then continuously rolled to a desired foil thickness (which can be either an intermediate or final thickness) and thermally reacted into a foil sheet 50 shown in FIG. 3, as will be explained in greater detail below.

Typically, the first central layer 10 comprises a common commercial ferritic stainless steel with between about 10.5 wt % to about 18.0 wt % Cr, and the balance Fe with other unavoidable residual elements. Examples of such ferritic stainless steels are AISI 405, 409, 430 and 439 stainless steels. Preferably, top and bottom layers 12 and 14 are of the same thickness and material, and are comprised of essentially pure aluminum, although aluminum alloys could also be used.

It is to be understood that the invention could equally well be practiced with a central relatively thinner layer of aluminum or aluminum alloys, and top and bottom layer of the ferritic stainless steel material. The invention will be described below using the Al/FeCr stainless steel/Al configuration as the example.

In a preferred embodiment having excellent medium-high temperature oxygen corrosion resistance, it has been found desirable to have a final chemistry in the final material 50 after thermal reaction (to be explained in detail below) of between about 9 wt % to about 18 wt % Cr, at least about 4 wt % and up to 9 wt % Al and the balance Fe. Additionally, small amounts of niobium (Nb) or titanium (Ti) can be added to either of the metals forming the composite to form nitride or carbide with carbon and nitrogen to reduce the amount of such free interstitial elements in a solid solution. It should be pointed out that the need to include small amounts of Y, Hf, Zr, or a rare earth metal element such as lanthanum (La), cerium (Ce), praseodymium (Pr), neodymium (Nd), etc., beyond that which is normally inherently present in stainless steel, is eliminated when forming the composite of the present invention. The presence of excess Y, Hf, Zr, or a rare earth metal element has been found to not be required in the alloys of the invention for the medium-high temperature oxidation resistance and dimension stability required for diesel engine catalytic converter applications, unlike the typical gasoline engine automotive application. In addition, Nb or Ti is not a necessary alloying element in the alloys of the invention for the medium-high temperature oxidation resistance and dimension stability required for catalytic converter applications if C is less than 0.08% and N is less than 0.05%. On the other hand, Al is an indispensable element for forming a protective aluminum oxide film on the surface to protect the alloy at elevated temperatures. The high content of Al in the alloys of the invention not only guarantees the good oxidation resistance, but also ensures the good adhesion of catalysis washcoat (normally is Al₂O₃ base) to the pre-oxidized alloy foil (with Al₂O₃ film on the alloy surface) using the existing catalysis washcoating process. The late part of Al roles in the alloys is important in washcoating manufacturing practice.

An example of such an embodiment is where a layer of AISI430 stainless steel, having a thickness typically of between 0.050 and 0.075 of an inch, is roll bonded to essentially pure aluminum top and bottom layers having a thickness typically of between 0.004 and 0.009 of an inch thereby yielding a bonded composite of approximately 0.015 to 0.040 of an inch as shown in FIG. 3. The initial starting thicknesses of the layers have been chosen to determine the ultimate chemistry of the final composite after thermal reaction. To obtain desirable high integrity and adhesion of bonding between layers in the sandwich composite and to avoid possible surface Al-layer peeling-off during further cold-rolling of the sandwich composite to a thin foil thickness, without any intermediate annealing at a low or medium temperature below 650° C., high reduction of roll-bonding is needed for metallurgical bond between the layers. To obtain such a result, a reduction in thickness under pressure should be high enough, e.g. above 45%, preferably above 50%, in one rolling-pass during roll-bonding such that high bond integrity and bond adhesion is achieved. Accordingly, an intermediate step of annealing at temperature of below about 650° C. for bond integrity and adhesion is then not necessary during further processing of the sandwich composite to a thinner thickness, down to about 0.001 inch.

There are two deviated approach paths to form the final product after roll bonding as described above:

In the first case, the composite 24 as shown in FIG. 2 is cold rolled by conventional means from the bonding thickness to a pre-selected intermediate thickness. The intermediate thickness lies between the bonding thickness and final foil thickness. The intermediate thickness is chosen per U.S. Pat. No. 5,980,658, incorporated herein by reference, so that the percentage reduction from the intermediate thickness to final foil thickness will be about 50% to about 75%. At this intermediate thickness, the rolled foil is then internally reacted or heat treated at a temperature between about 900° C. and about 1200° C., and preferably at about 1000° C. for between 1 minute and 60 minutes or longer as required to provide for diffusion of the various constituents in the composite throughout the foil material. That is, after this heat-treating operation, also referred to as diffusion annealing, the microstructure of the foil will not be the original three-layer structure; but instead a monolithic, uniform or nearly uniform, solid solution alloy as shown in FIG. 5 will be created. It is preferable that the heat-treating be for a period of time that is sufficient to dissolve any formed intermetallic compounds. This heat treating is done preferably at a temperature which does not allow for the formation of a brittle sigma phase of CrFe or other brittle compounds. The heat treating can be done in a vacuum, reducing atmosphere or in an inert atmosphere or in air. The diffusion-annealed foil at the intermediate thickness is then finish rolled to a final foil thickness. This final thickness foil can be used for catalytic converter fabrication, to produce the honeycomb-like substrates used in catalytic converters.

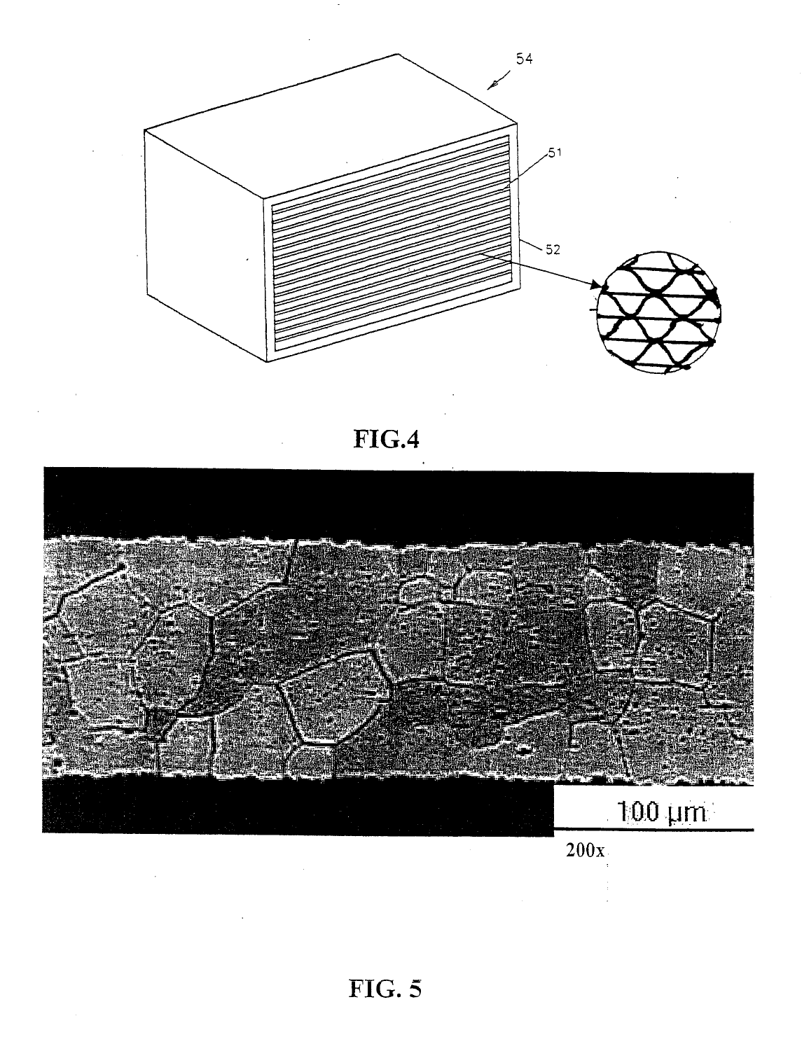

In the second case, the composite 24 is cold rolled by conventional means from the bonding thickness to the final foil thickness, typically of about 0.002 inches thereby forming a finished foil. This finish rolled foil is then cleaned, corrugated and stacked or wound to form a substrate structure with a certain means of restraining at its outside such as shown in FIG. 4. The honeycomb-like catalytic converter body and thus the composite foil is then thermally reacted or heat treated at a temperature between about 900° C. and about 1200° C., and preferably about or above 1000° C., for between 1 minute and 60 minutes or longer to provide for diffusion of the various constituents in the composite throughout the foil material. That is, after this heat-treating operation, also referred to as diffusion annealing, the microstructure of the foil will not be the original three-layer structure; but instead a monolithic, uniform or nearly uniform, solid solution alloy. It is preferable that the heat-treating be for a period of time that is sufficient to dissolve any formed intermetallic compounds. This heat treating is done preferably at a temperature which does not allow for the formation of a brittle sigma phase of CrFe or other brittle compounds. The heat treating can be done in a vacuum, reducing atmosphere or in an inert atmosphere or in air.

Before the diffusion annealing heat treatment, in both cases, the residual oil and other foreign contaminations from processes, such as cold-rolling or forming, should be remove. The removal of contaminants from the outer surface of the composite material is desirable to avoid, for example, carbon pick up in the alloy during the diffusion annealing process. A cleaning step is critical prior to the annealing for diffusion. Various conventional cleaning methods can be employed in accordance with the present invention provided that the cleaning step is not detrimental to the integrity of the outer surface of the composite material. A conventional alkaline cleaning process, normally with a mechanical agitation by brushes, is commonly employed for cleaning of metals. However, because the thickness of Al layer at the outside surfaces of the sandwich composite is very thin after cold-rolling, non-brush and non-abrasive cleaning process is preferred. In addition, alkaline ions from the solution in the conventional alkaline cleaning process might be left on the surfaces of the composites which, in turn, may cause the contamination of alloy surfaces during heat treating for diffusion. A petroleum-based solvent, applied by spray (as disclosed in U.S. Pat. No. 6,379,468) is preferred to effectively remove any residual oil and other contaminants while avoiding surface disruption and/or mechanical damage of the composite.

In the second case (where the composite is cold rolled to the final thickness before catalytic converter fabrication and diffusion heat treatment), brazing is a basic process for many different catalytic converter fabrication approaches. The brazing of honeycomb-like catalytic converters normally uses Ni-based brazing alloys and its heating temperature is usually above 900° C. This temperature falls in the temperature range of diffusion heat treatment of the composites, and thus an in-situ diffusion of catalytic converters fabricated directly from the composite foil of the invention alloy is possible during brazing. This invention identified that the full conversion of the composite to a uniform, solid-solution single alloy through diffusion occurred after a brazing at temperature between 1150 to 1200° C. for a certain time, while brazed joints in the catalytic converters have good joint strength.

In order to give greater appreciation of the advantages of the invention, the following examples are given:

### EXAMPLE I

A continuous strip of annealed commercial AISI430 stainless steel containing 17% Cr at a thickness of 0.077 of an inch was sandwiched between two continuous strips of Al foils in a single operation to yield a solid state metallurgically bonded three layer composite as described in U.S. Pat. No. 5,366,139. A 60% reduction in thickness by one rolling pass during the roll-bonding operation for the metallurgical bond was achieved. The continuous strip was cold rolled to an intermediate thickness of 0.004 inches. This foil composite material was then cleaned by petroleum-based solvent without mechanical brushing action on the Al surfaces of the composite strip and heated to 1000° C. under vacuum for 90 minutes to diffuse all the aluminum into the stainless steel base, thereby forming a uniform, solid solution alloy foil material. The foil material was then cold-rolled to a final thickness of 0.002 inches. The foil material shows a nominal chemical composition (in weight percentage) of:
Cr: 16.4%
Al: 5.2%
C: 0.05%
Ni: 0.2%
Mn: 0.5%
S: 0.001%
La: <0.001%
Ce: <0.002%
Pr: 0.003%
Y: <0.0005%
Hf: <0.002%
Zr: 0.003%
Ti: 0.004%

### EXAMPLE II

This example was carried out in process steps that were identical to Example I above except the starting thickness of the AISI430 stainless steel center strip used was at 0.060 inches. Therefore, the finished, uniform solid solution alloy foil material has 15.2% Cr and 7.2% Al, with the amounts of minor chemical composition being virtually identical to Example I.

### EXAMPLE II

This example was carried out identical to Example I above except that the AISI430 stainless steel in the central strip was replaced by a AISI409 stainless steel containing nominally 12% Cr with minor amount of Ti, at a thickness of 0.075 inch. After the processing, the finished, uniform solid solution alloy foil material shows a chemical composition (in weight percentage) of:
Cr: 11.3%
Al: 5.8%
C: 0.05%
Ni: 0.2%
Mn: 0.4%
S: 0.001%
La: <0.001%
Ce: <0.002%
Pr: <0.005%
Y: <0.0005%
Hf: <0.002%
Zr: 0.004%
Ti: 0.32%
Nb: 0.01%

### EXAMPLE IV

This example was carried out identical to Example III above except the starting thickness of the 409 stainless steel center strip used was at 0.062 inches. Therefore, the finished, uniform solid solution alloy foil material has 11.2% Cr and 6.6% Al, with the amounts of minor chemical composition being virtually identical the same as in EXAMPLE III.

Table 1 lists nominal chemical compositions of the materials in Examples I to IV in weight percentage.

TABLE 1
Chemical Composition of the Materials (Weight %)

| Example | Cr | Al | C | Mn | Si | Ni | La | Ce | Pr | Hf | Y | Ti | Nb | Zr | N | S |
|---|---|---|---|---|---|---|---|---|---|---|---|---|---|---|---|---|
| I | 16.4 | 5.2 | 0.05 | 0.4 | 0.4 | 0.2 | 0.0008 | 0.0016 | 0.003 | <0.002 | <0.0005 | 0.004 | — | 0.003 | 0.01 | 0.001 |
| II | 15.2 | 7.1 | 0.05 | 0.4 | 0.4 | 0.2 | 0.0009 | 0.0016 | 0.003 | <0.002 | <0.0005 | 0.004 | — | 0.003 | 0.01 | 0.001 |
| III | 11.3 | 5.8 | 0.03 | 0.3 | 0.5 | 0.2 | 0.0006 | 0.0018 | 0.004 | <0.002 | <0.0005 | 0.32 | 0.01 | 0.004 | 0.01 | 0.001 |
| IV | 11.1 | 6.6 | 0.03 | 0.3 | 0.5 | 0.2 | 0.0006 | 0.0018 | 0.004 | <0.002 | <0.0005 | 0.3 | 0.006 | 0.003 | 0.01 | 0.001 |

### EXAMPLE V

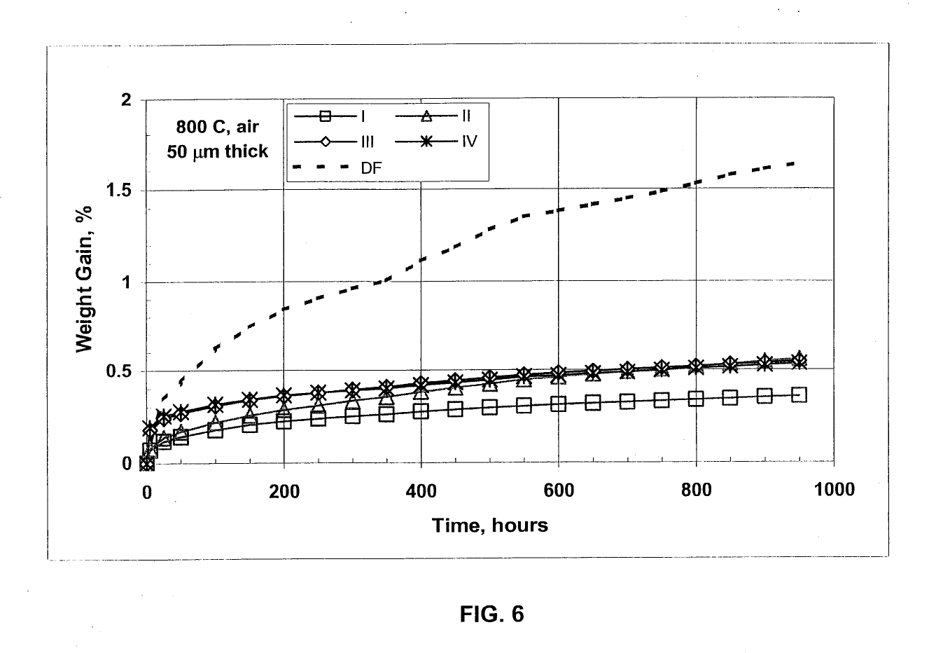

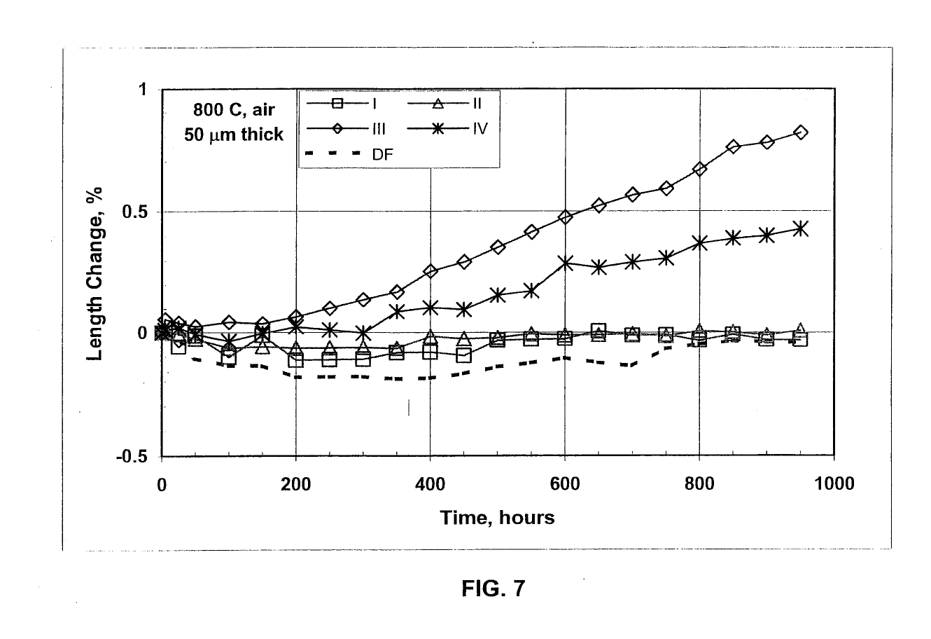

The final rolled foil material having a thickness of 0.002 inches made in Examples I, II, III and IV was corrugated and wound with a flat foil of the same material, respectively, to form a honeycomb-like test sample roll. The honeycomb-like samples were annealed at 1150° C. for 30 minutes in vacuum. Then, the honeycomb-like catalytic converter test samples were tested in air in a cyclic fashion for oxidation resistance and dimension stability. The samples were heated from ambient to 800° C. in 2 hours and held for a period of time followed by cooling to ambient in 6 hours in air. The holding period started at 5 hours then 20 hours followed by 25 hours, and repeated at 50 hours, until the accumulated time at 800° C. reached 950 hours. The weight gain from oxidation and the length change between two ends of the rolls were measured at the end of each cycle. FIGS. 6 and 7 show the test results of oxidation weight gains and length changes, respectively.

The results in FIGS. 6 and 7 demonstrate that the materials have good oxidation resistance and dimension stability at 800° C. in air. The weight gain followed a parabolic fashion which indicates that the protective scale was intact. The lengths of test sample rolls were constant through the test which demonstrated that no rapid deterioration of materials took place.

In FIGS. 6 and 7, a reference material (identified as DF) was included, having a nominal composition (in weight percentage) of:
Cr: 21%
Al: 6.3%
C: 0.013%
Ni:0.13%
Mn: 0.29%
S: 0.0003%
La: 0.0099%
Ce: 0.031%

This reference material contained higher chromium content as well, the rare earth elements of lanthanum and cerium, and is relatively costly to process to the foil thickness with about 6% aluminum. It is a nominal material for a gasoline engine catalytic converter. The materials in this invention have similar oxidation resistance and dimension stability at 800° C. to the reference material.

### EXAMPLE VI

This example was carried out identical to Examples I to IV above except the cold rolling after roll bonding continued to the final thickness of 0.002 inches prior to the diffusion annealing. The composite foil materials were cleaned by petroleum-based solvent without mechanical brushes. Each type of composite foil was corrugated and wound with a flat composite foil material of the same type, to make a honeycomb-like sample roll. The honeycomb-like roll test samples were heated to 1150° C. and held for 30 minutes followed by cooling in vacuum. The chemical compositions of the four test samples were virtually the same as the corresponding materials in Examples I, II, III and IV, respectively.

### EXAMPLE VII

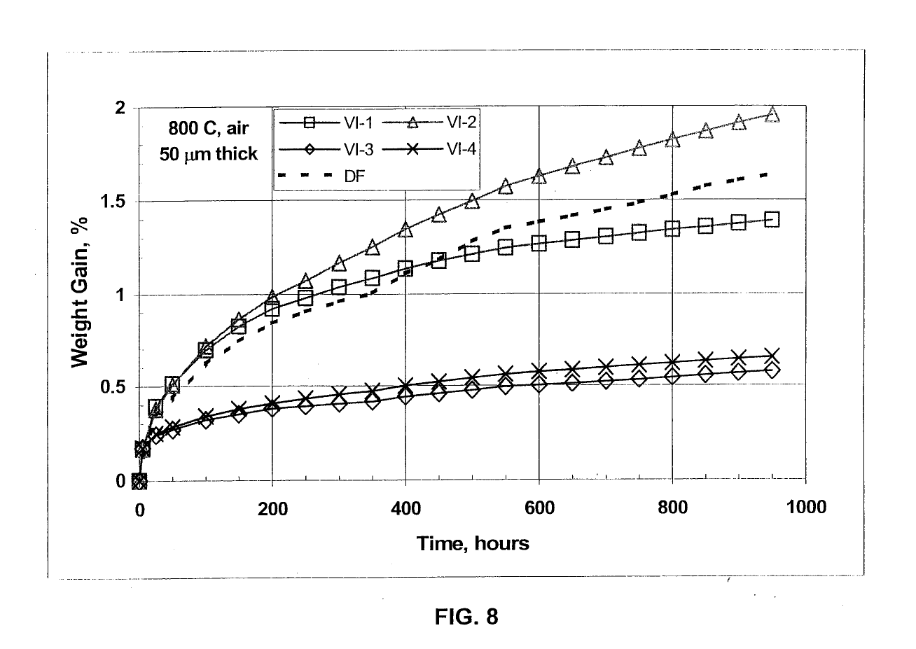

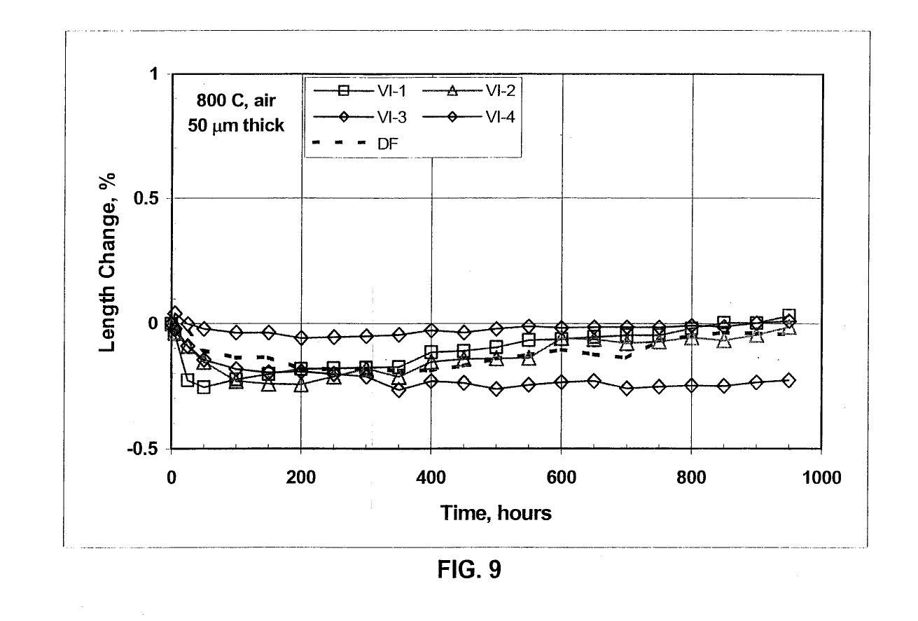

The honeycomb-like roll samples of Example VI were tested for oxidation weight gain and dimensional stability as described in Example V. The test results, seen in FIGS. 8 and 9, showed that the materials have good oxidation resistance (low oxidation weight gain) and dimension stability (constant length). Again, the oxidation resistance and dimension stability of the invented materials are similar to the reference material DF (having higher Cr % and containing rare earth elements La and Ce) at 800° C.

Table 2 summarizes the tests results of oxidation weight gain and length change percentage after total accumulated 950 hours tested at 800° C. in air.

TABLE 2
Summary of Test Results

| | Example | | | | | | | | |
|---|---|---|---|---|---|---|---|---|---|
| | I | II | III | IV | VI-1 | VI-2 | VI-3 | VI-4 | DF |
| Weight | 0.35 | 0.56 | 0.55 | 0.53 | 1.39 | 1.95 | 0.58 | 0.65 | 1.63 |
| Gain | | | | | | | | | |
| % | | | | | | | | | |
| Length | −0.03 | 0.01 | 0.82 | 0.43 | 0.03 | −0.01 | 0.01 | −0.23 | −0.04 |
| Change | | | | | | | | | |
| % | | | | | | | | | |

### EXAMPLE VIII

This example was carried out identical to Example 1 above with the exception that 1) the starting thickness of the 430 steel center strip was at 0.070 inches, and 2) heating for diffusion was 960° C. for 2 hours. Therefore, the finished, uniformed solid solution alloy foil materials has 15.0% Cr and 5.5% Al, with the amounts of minor chemical composition being virtually the same as in Example 1. Again, no Y, Hf, Zr, Ti, or any other rare earth elements such as La, Cr, Pr or, Sm were added to the alloy. The oxidation testing of this alloy was carried out as described in Example V, with additional test temperature at 900° C.

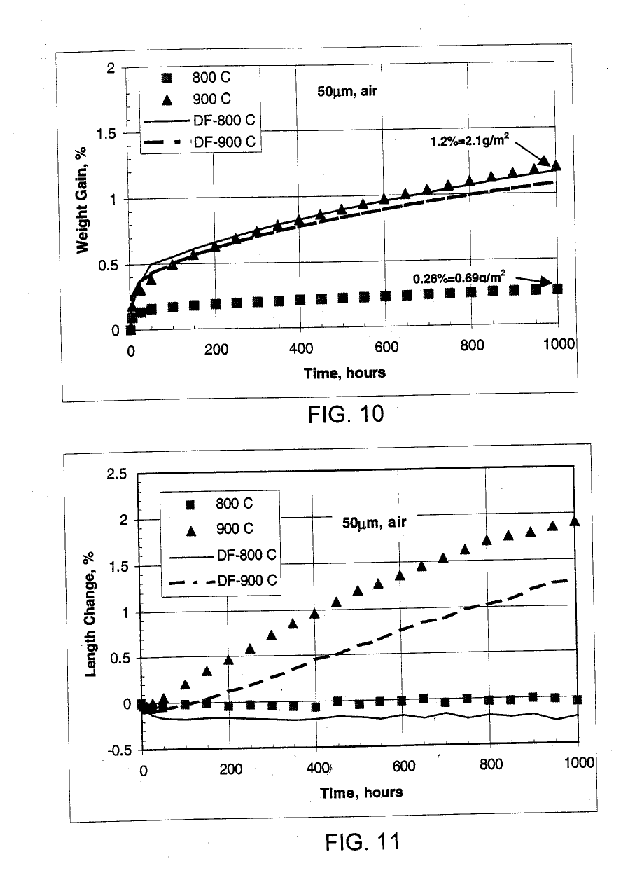

It is noted that the foil material of the invention has good oxidation resistance with a low weight gain at 900° C., when compared to the reference material DF with high chromium 21 % Cr and rare earth addition of, La and Ce (FIG. 10). The foil material has good dimension stability at 900° C. that is comparable to the reference material DF (FIG. 11).

### EXAMPLE IX

In this example, the bonded material was identical to that in Example VIII above, while cold rolling continued to a final thickness of 0.0020 inches prior to the diffusion annealing heat treatment. After a solvent cleaning as described in prior examples, the composite foil was corrugated and wound with a flat composite foil of the same type, to make honeycomb-like sample rolls. A nickel-based brazing alloy powder (American Welding Society BNi5 type) was applied between the flat and corrugated foils. Three different vacuum brazing cycles were used on these samples rolls,
1) 1150° C.×30 min
2) 1180° C.×30 min
3) 950° C.×30 min+1150° C.×30 min.

After brazing, the composite foil material has been completely transferred to a uniform, single phase, solid state solution of FeCrAl alloy with bulk chemistry the same as the alloy in Example VIII.

A customized push-out test on the sample rolls was carried out to examine the brazed joint strength. A compression load was applied by a solid push rod on the honeycomb-like sample roll (100 mm diameter×89 mm height), which was place in a heavy-wall cylinder. The testing showed that the brazed joints in the testing sample converters had high joint strength with a maximum crush load above 1100 lbs. Further, breaks did not occur at brazed joints. The difference of the push-out strength of the brazed converters made directly from the composite foil compared to the brazed converters made from the uniform, solid solution single alloy foil was within +/−5% when they were possessed with the same brazing process.

This demonstrates that the diffusion for the composite foil to transfer to uniform, solid solution alloy could happen at the same time of brazing during a single step brazing heat treatment.

### EXAMPLE X

This example was carried out with the processes identical to Example IX using brazing schedule 1). The brazed sample rolls were then heated at 900° C. in air. After holding for a time between 10 minutes and 120 minutes at the temperature followed by furnace cooling, the alloy developed a rough aluminum oxide surface. Under scanning electron microscope, whisker or needle scales on the alloy surface were observed. Such rough surface morphology provides adhesion of the washcoat to foil substrate by a mechanical pegging mechanism. An adhesion test showed good adhesion of the washcoat to the surface of metal foil in a catalytic converters from foils produced as described in this invention.

The novel process and article produced by method of the present invention provides for a foil material for use in catalytic converters with good corrosion resistance at elevated temperatures of about at least 800° C., and more preferably at least about 900° C. wherein the need for inclusion of additional Y, Hf, Zr, and/or rare earth elements, beyond that which is inherently present in commercially available stainless steels, is eliminated. The material is easily and economically manufactured to a selectively predetermined desired chemical composition. The chemical composition is uniform throughout the foil sheet.

The invention has been described hereinabove using specific examples. However, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

1. A method for making a foil substrate material for catalytic converters which operate at temperatures of up to about 900° C., comprising the steps of:
a) providing a first layer of a first material selected from FeCr metals, aluminum and aluminum alloys;
b) sandwiching the first layer of the first material between a first and second layer of one or more second material(s) which is different from the first material and is selected from FeCr metals, aluminum and aluminum alloys, thereby producing a multilayer composite having two outer surfaces;
c) compaction rolling the multilayer composite to form an intermediate thickness composite foil;
d) cleaning the two outer surfaces;
e) heating the intermediate thickness composite foil at a temperature of between about 900° C. to about 1200° C. for a period of time which is sufficient to cause diffusion of said one or more second metal materials into said first metal materials to produce a uniform, solid solution alloy foil;
f) cooling the uniform, solid solution alloy foil to room temperature;
g) rolling the uniform, solid solution alloy foil to a finish thickness.

2. The method according to claim 1 wherein said first material is a FeCr stainless steel and said second material is aluminum or aluminum alloy.

3. The method according to claim 2, wherein the FeCr stainless steel is selected from stainless steel AISI405, 430, 439 and 409.

4. The method according to claim 1 wherein said heating step e) further comprises maintaining said multilayer composite material at peak temperature for between about 1 and about 60 minutes.

5. The method according to claim 1 wherein a chemical composition of the uniform, solid solution alloy foil of step g) is between about 9 wt % and 18 wt % Cr, at least about 4 wt % up to about 9 wt % Al, and the balance Fe.

6. The method according to claim 1 wherein said intermediate thickness is between about 0.002 inches and about 0.008 inches.

7. The method according to claim 6 wherein said finish thickness is between about 0.0010 inches and about 0.003 inches.

8. The method of claim 1 wherein a thickness reduction from said intermediate thickness and said finish thickness is between about 50% and 75%.

9. The method according to claim 1 further including annealing the uniform, solid solution finish thickness alloy foil formed in step g).

10. A method for making catalytic converters which operate at temperatures of up to about 900° C. wherein the catalytic converter contains structures comprising a foil substrate material, comprising the steps of:
a) providing a first layer of a first material selected from FeCr metals, aluminum and aluminum alloys;
b) sandwiching the first layer of the first material between a first and second layer of one or more second material(s) which is different from the first material and is selected from FeCr metals, aluminum and aluminum alloys, thereby producing a multilayer composite having two outer surfaces;
c) compaction rolling the multilayer composite to form a finish thickness composite foil;
d) cleaning the two outer surfaces;
e) forming the finish thickness composite foil into structures used in a catalytic converters, including wavy-like or corrugated structures and flat structures, and incorporating the structures into a honeycomb-like catalytic converter body thereby forming a catalytic converter with air-flow channels;
f) heating the catalytic converter containing the structures formed from the finish thickness composite foil at a temperature of between about 900° C. to about 1200° C. for a period of time which is sufficient to cause diffusion of said one or more second metal materials into said first metal materials contained in the finish thickness composite material to produce a uniform, solid solution alloy foil containing catalytic converter;
g) cooling the uniform, solid solution alloy foil containing catalytic converter to room temperature.

11. The method according to claim 10 wherein said first material is a FeCr stainless steel and said second material is aluminum or aluminum alloy.

12. The method according to claim 11 wherein the FeCr stainless steel is selected from stainless steel AISI405, 430, 439 and 409.

13. The method according to claim 10 wherein said heating step f) further comprises maintaining said catalytic converter at peak temperature for between about 1 and about 60 minutes.

14. The method according to claim 10 wherein a chemical composition of the uniform, solid solution alloy foil is between about 9 wt % and 18 wt % Cr, at least about 4 wt % up to about 9 wt % Al, and the balance Fe.

15. The method according to claim 10 wherein said finish thickness composite foil is between about 0.0010 inches and about 0.003 inches.

16. The method according to claim 10 further including annealing the uniform, solid solution finish thickness alloy foil containing catalytic converter formed in step g).

17. A product produced in accordance with the process of claim 1.

18. A product produced in accordance with the process of claim 2.

19. A product produced in accordance with the process of claim 10.

20. A product produced in accordance with the process of claim 11.

21. A catalytic converter comprising a product of claim 17.

22. A catalytic converter comprising a product of claim 18.

23. The method of claim 1 wherein the cleaning step d) comprises cleaning with a petroleum based solvent.

24. The method of claim 23 wherein mechanical cleaning is avoided.

25. The method of claim 10 wherein the cleaning step d) comprises cleaning with a petroleum based solvent.

26. The method of claim 25 wherein mechanical cleaning is avoided.
